(19) United States
(12) Patent Application Publication
(10) Pub. No.: US 2025/0078130 A1
(43) Pub. Date: Mar. 6, 2025

(54) SYSTEMS AND METHODS FOR OPTIMIZING PRODUCT FEEDS FOR PRICE COMPARSION SHOPPING WEBSITES

(71) Applicant: COUPANG CORP., Seoul (KR)

(72) Inventors: Chenyu WANG, San Mateo, CA (US); Xinli BAO, Palo Alto, CA (US)

(73) Assignee: COUPANG CORP., Seoul (KR)

(21) Appl. No.: 18/460,336

(22) Filed: Sep. 1, 2023

(51) Int. Cl. G06Q 30/0601; G06Q 30/0201

(52) U.S. Cl. CPC G06Q 30/0629; G06Q 30/0201; G06Q 30/0635; G06Q 30/0643

(57) ABSTRACT

Systems and methods are disclosed for operations for optimizing a product feed based on a machine learning model trained on product data. The operations comprise obtaining historical product data corresponding to a first product set, the first product set comprising one or more products for display on a webpage associated with the system. The operations comprise determining a capacity constraint associated with a second system configured to display information associated with the one or more products and generating, with a machine learning model trained on the historical product data, a predicted amount of interactions corresponding to at least one product in the first product set. The operations comprise selecting, based on the predicted amount of interactions, a second product set, the second product set includes a subset of the products from the first product set based on the capacity constraint and presenting the second product set to the second system.

### TECHNICAL FIELD

The present disclosure generally relates to computerized systems and methods for optimizing data feeds based on a machine learning model trained on data. In particular, embodiments of the present disclosure relate to inventive and unconventional systems relate to optimizing data feeds for transmission to a remote system.

### BACKGROUND

Data transmission between remote systems can be limited by technological challenges, including the size of data transmitted. In particular, generating a data feed, and sending a data feed to a remote system for utilizing the data or displaying the data feed may be limited by the size of the data feed or the number of items in the data feed. For example, in online marketing, retailers can upload one or more product data feeds to comparison shopping websites, which can help retailers reach wider audiences and increase sales. The products in the data feed then appear on the comparison shopping engine alongside similar products from other retailers. A challenging technical problem to solve is to figure out what products to upload to maximize sales given that the comparison shopping websites and often have a limit on the size of the product feed. Conventionally, marketers have implemented business rules such as choosing the products that have been viewed in the past 90 days or sold within the last year or have been clicked on before. These rules would usually be built on a one-off piece of analysis and picking the final list to meet the size requirement usually involves selection based on randomness or intuition. This results in manual, sub-optimal product feed selection strategies built on human-driven ad hoc rules and strategies.

Further, data from products listed on retail websites exists in various formats, and there are large amounts of data available for different products and different users. Extracting meaningful information to make predictions based on such data is also a technologically challenging problem. Therefore, there is a need for improved methods and systems for optimizing a product feed based on a machine learning model trained on product data.

### SUMMARY

One aspect of the present disclosure is directed to a system for optimizing a product feed based on a machine learning model trained on product data. One aspect of the present disclosure is directed to obtaining historical product data corresponding to a first product set, the first product set comprising one or more products for display on a webpage associated with the system. One aspect of the present disclosure is directed to determining a capacity constraint associated with a second system configured to display information associated with the one or more products. One aspect of the present disclosure is directed to generating, with a machine learning model trained on the historical product data, a predicted amount of interactions corresponding to at least one product in the first product set. One aspect of the present disclosure is directed to selecting, based on the predicted amount of interactions, a second product set, wherein the second product set includes a subset of the products from the first product set based on the capacity constraint. One aspect of the present disclosure is directed to presenting the second product to the second system.

Another aspect of the present disclosure is directed to generating, on a daily basis, aggregated product data based on the historical product data, the historical product data corresponding to a historical time duration. Another aspect of the present disclosure is directed to applying one or more calculations to the historical product data, combining the historical product data into a unified record, storing the unified record into a database, and inputting the aggregated product data into the machine learning model daily.

Another aspect of the present disclosure is directed to tuning one or more hyperparameters associated with the machine learning model by applying Bayesian optimization to the one or more hyperparameters. Another aspect of the present disclosure is directed to generating the predicted amount of interactions based on at least one of historical product data or new product data.

Another aspect of the present disclosure is directed to obtaining from the second system a product feed and a product feed click count, providing at least one of the product feed or the product feed click count to the machine learning model, and updating one or more weights in the machine learning model by training the machine learning model based on the at least one of the product feed or the product feed click count. In some embodiments, the machine learning model is updated daily. In some embodiments, the historical product data include at least one of vendor information, score information, product review information, customer information, sales information, or interactions corresponding to the retail website. In some embodiments, a total amount of products in the second product set is no more than the capacity constraint.

Another aspect of the present disclosure is directed to associating each product in the first set of products with a product feed key, the product feed key comprising a product identifier and a price; and mapping the product feed key to a product in the second system. In some embodiments, the generated predicted amount of interactions corresponds to a future time period.

Yet another aspect of the present disclosure is directed to a non-transitory computer readable medium including instructions that are executable by one or more processors to cause a system to perform a method for optimizing a product feed based on a machine learning model trained on product data. Another aspect of the present disclosure is directed to obtaining historical product data corresponding to a first product set, wherein the first product set comprising one or more products for display on a webpage associated with the system. Another aspect of the present disclosure is directed to determining a capacity constraint associated with a second system configured to display information associated with the one or more products; wherein the capacity constraint comprises a numerical limit. Another aspect of the present disclosure is directed to generating a gradient boosting machine regression model configured to generate a predicted amount of interactions corresponding to at least one product in the first product set. Another aspect of the present disclosure is directed to training, on a daily basis, the gradient boosting machine regression model by generating aggregated product data based on the historical product data, inputting the aggregated product data into the gradient boosting machine, obtaining from the second system a product feed; and a product feed click count, providing at least one of the product feed or the product feed click count to the machine learning model; and optimizing the trained gradient boosting machine model by applying Bayesian optimization to one or more hyperparameters associated with the trained gradient boosting machine model. Another aspect of the present disclosure is directed to generating, with the optimized gradient boosting machine model, the predicted amount of interactions; wherein the predicted amount of interactions corresponds to a future time interval. Another aspect of the present disclosure is directed to selecting, based on the predicted amount of interactions, a second product set, wherein the second product set includes a subset of the one or more products from the first product set based on the capacity constraint and presenting the second product set to the second system for display during the future time interval.

Other systems, methods, and computer-readable media are also discussed herein. Disclosed embodiments may include any of the above aspects alone or in combination with one or more aspects, whether implemented as a method, by at least one processor, and/or stored as executable instructions on non-transitory computer readable media.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is an illustration of an exemplary retail website and comparison shopping website, consistent with embodiments of the present disclosure.

FIG. 4 is an illustration of an exemplary diagram for training and using a machine learning model, consistent with embodiments of the present disclosure.

FIG. 5 is an illustration of a user interacting with a system for optimizing a product feed, consistent with embodiments of the present disclosure.

FIG. 6 is an illustration of a block diagram of inputs to a machine learning model, consistent with embodiments of the present disclosure.

FIG. 7 is an illustration of a table displaying test results for a machine learning model, consistent with embodiments of the present disclosure.

FIG. 8 is an illustration of a flow diagram of a method for optimizing a product feed based on a machine learning model, consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for optimizing a data feed based on a machine learning model.

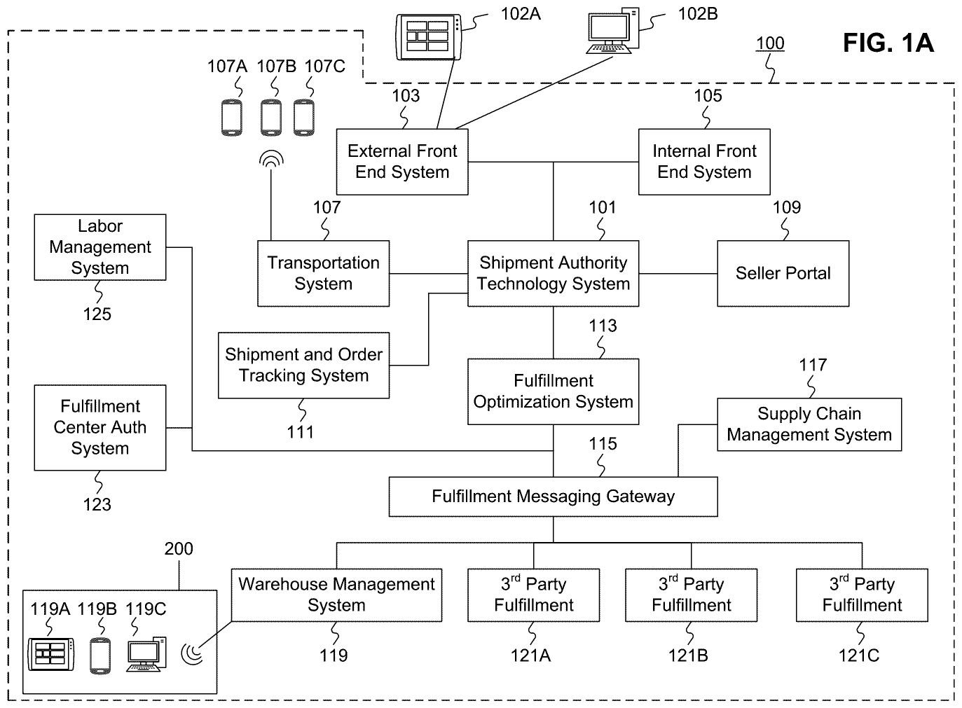

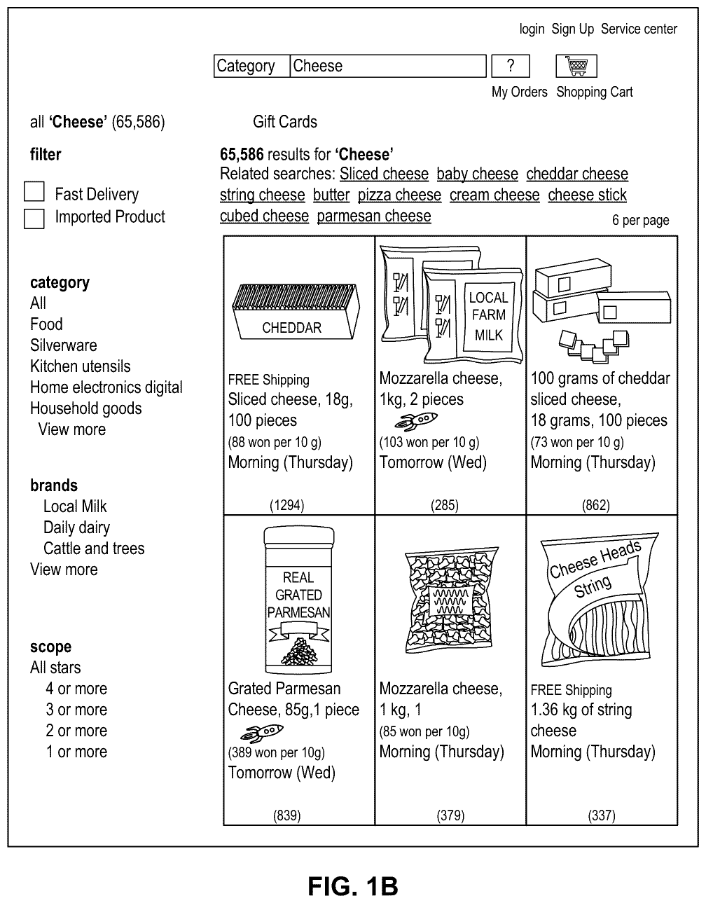

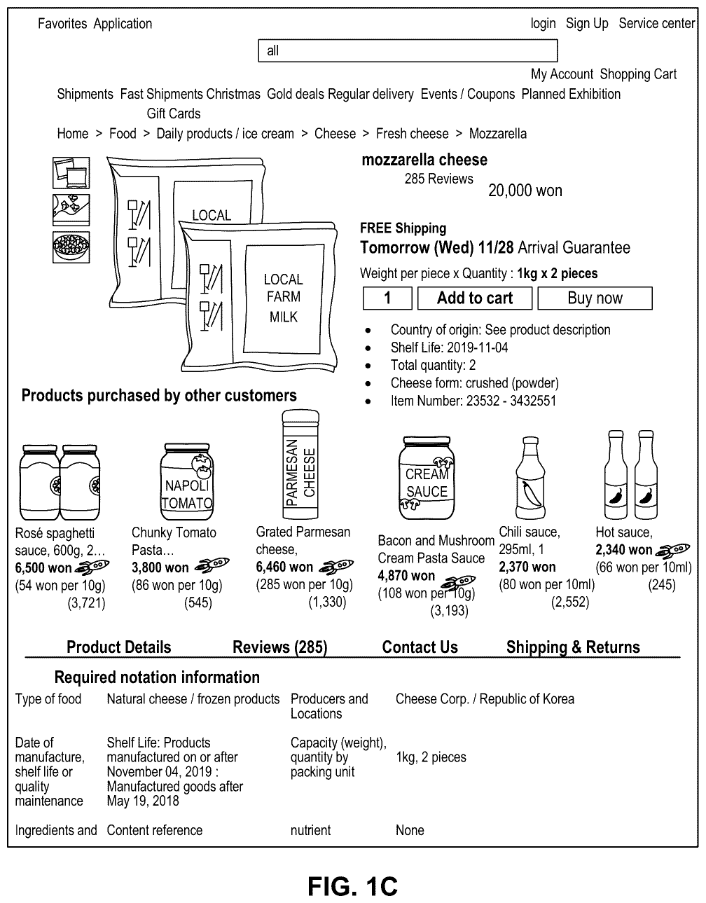

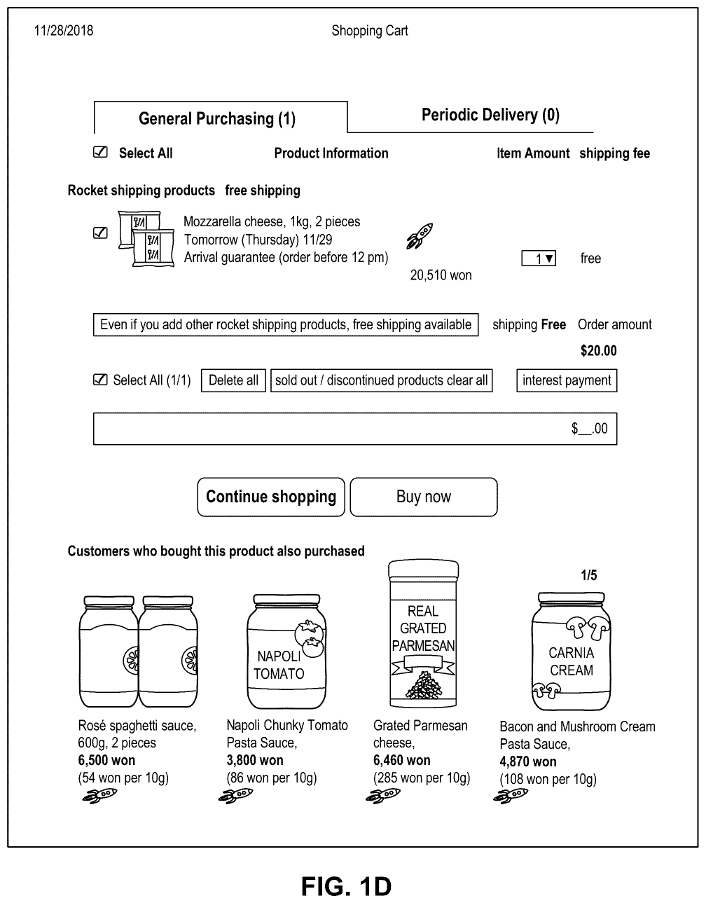

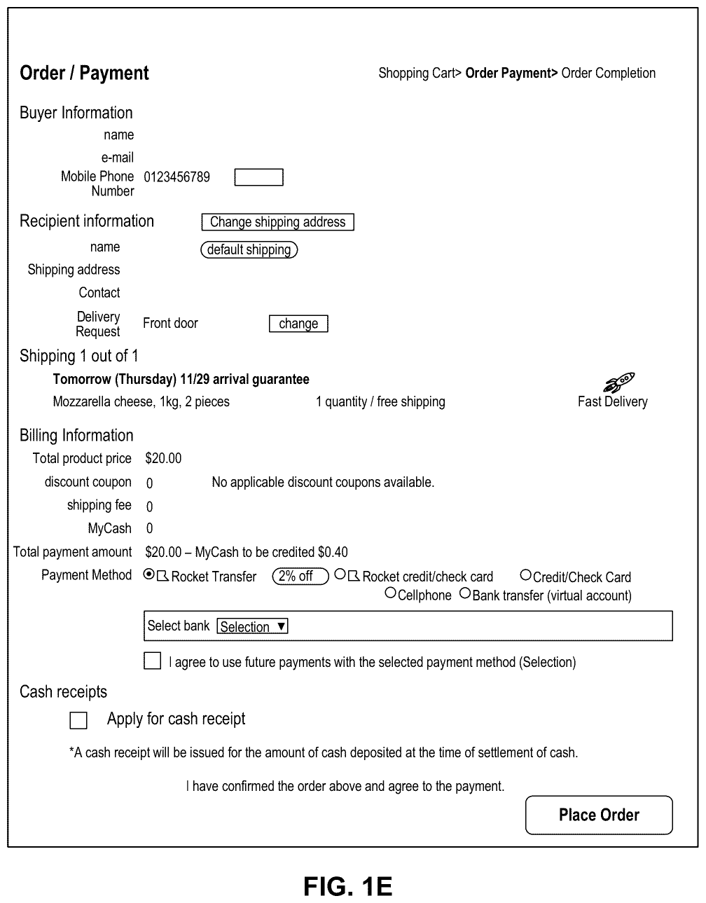

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

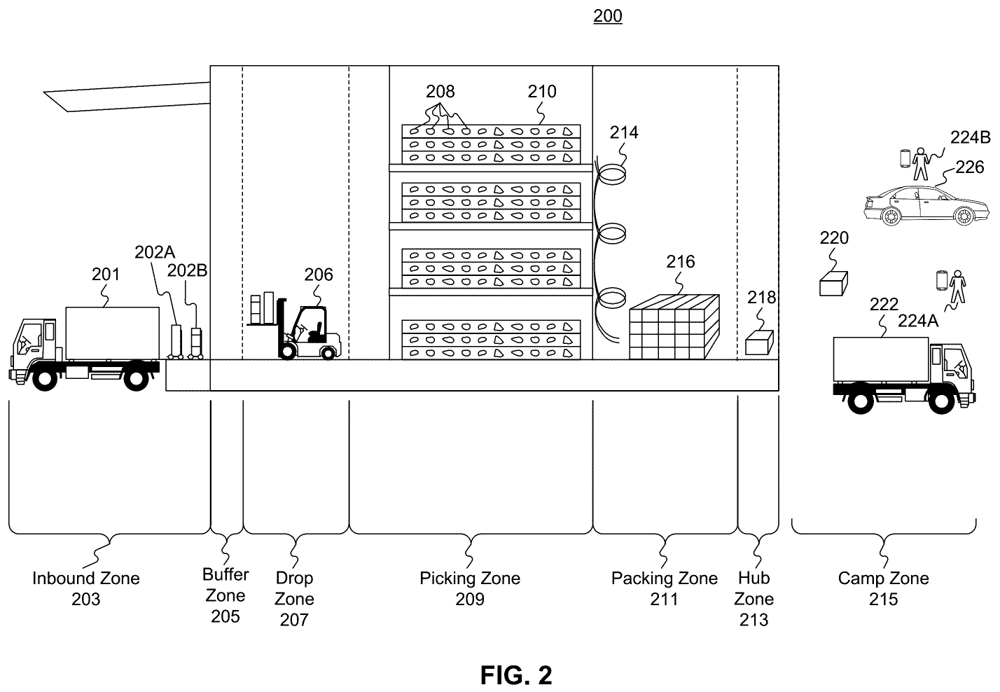

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

Disclosed embodiments may involve optimizing data feeds. Data feeds may include any list of information which may be displayed on a system. Data feeds may include information that are associated in some manner, such as by a certain field, category, or type, as well as data that are disparate. For example, data feeds may include listings, directories, catalogues, or the like, which may have certain limitations regarding the information available for use or for display.

Disclosed embodiments may involve products associated with one or more systems. Products may refer to any good or service available for sale or purchase. As a non-limiting example, products may include any item a consumer can buy, such as food, clothing, software, or furniture. In some examples, a system may be associated with a product by storing, displaying, or generating information corresponding to one or more products. Retailers, distributors, manufacturers, or third parties may provide product information to a system such as to display information about the product. For example, system 100, as referenced in FIG. 1, may store or display information corresponding to one or more products. In some embodiments, a system may display product information on the front-end, such as on a website or an application. For example, product information may be displayed by system 100 on an external front end system 103 or internal front end system 105 of a computer 102B. System 100 may present product information on a webpage or user interface of computer 102B. In some embodiments, system 100 may correspond to a retailer selling products from various manufacturers or sources.

In some embodiments, products may be displayed by one or more systems. For example, systems may correspond to the same or a different retailer, distributor, or manufacturer. Products associated with a first system may be electronically linked or in communication with a second system, such that a product displayed on the first system may be displayed on the second system. The second system may be configured to receive product information from a plurality of other systems and present the product information to a user. In some embodiments, a system may refer to any website configured to aggregate multiple product sources and display the product information on a single website. Such systems may refer to search engines, comparison shopping websites, or the like. A comparison shopping website may refer to a website where products may be compared on any criteria, such as price, features, customer reviews, popularity, or the like. Comparison shopping websites may present similar products, or the same product, from different retailers to a user. As used herein, comparison shopping websites may allow users to search for products based on a user query, such as entering a product name through a user interface or search bar. A comparison shopping website may refer to a comparison shopping websites, price comparison shopping engine, price analysis tool, comparison shopping agent, shopbot, aggregator or any vertical search engine that consumers can use to filter and compare products. For example, based on a user search, the price comparison website may present various product options to the user from different retailers. In an example, a search for a specific product, such as a shirt, may result in displaying results for the searched product from a variety of retailers. In an example, the comparison shopping website may present results from different retailers for the same brand or manufacturer of the searched product. In another example, the website may display results from different brands or manufactures of similar products to the searched product, such as displaying results for different brands of jeans if the searched product was jeans. It will be recognized that websites as described herein may also refer to applications and websites accessible through a mobile phone. In some examples, comparison shopping websites may include any website presenting an advertisement, such as a shopping advertisement or a search advertisement.

Some disclosed embodiments involve obtaining product data corresponding to a product set. Product data may involve any metric for measuring the demand of products, including data from vendors, manufacturers, retailers, and/or consumers. In some embodiments, product data may include any of vendor information, pictures, prices, score information, product review information, customer information, sales information, or interactions corresponding to the retail website. For example, product data may include data from a retail website, including retail website product reviews, search histories, and sales histories. Product data may include customer product purchase histories, customer browsing and search behaviors, product delivery histories, customer inquiries, and customer reviews. Product data may include vendor information, including delivery information, cancellation, and vendor risks. Product data may also include popularity of the product, product seasonality, brand information, and data corresponding to a product's performance in its category. In some examples, product data may include data corresponding to a product's geographical sales information, number of reviews, purchase volume in a given time frame, number of orders in a given time frame, number of clicks during an observation period, number of orders during an observation period, gross merchandise value, number of reviews, average review score, number of exposes, number of purchases, number of add to carts, and/or number of adds to wish list.

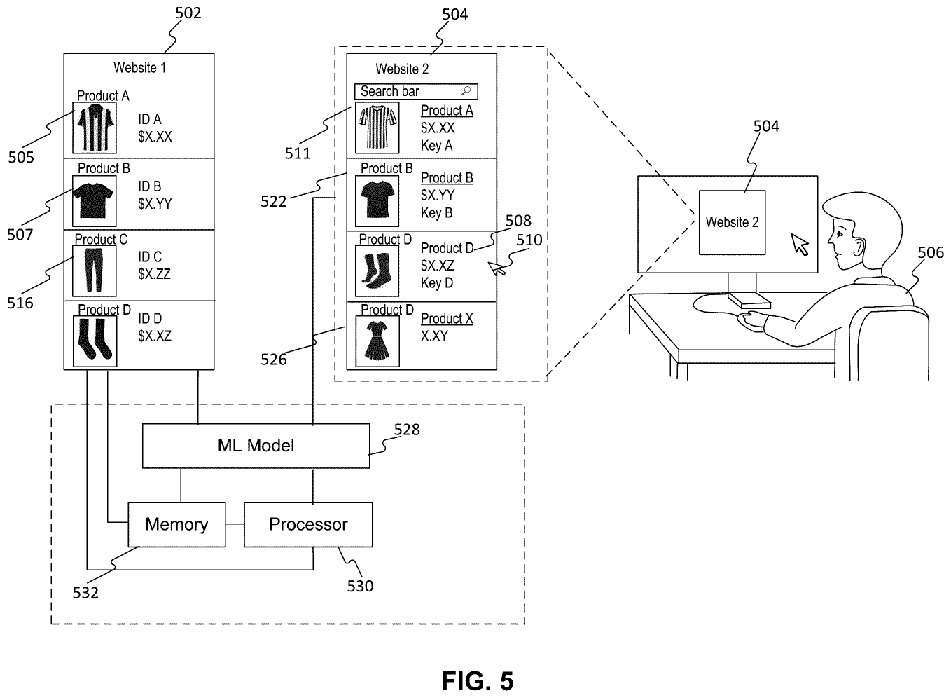

In some embodiments, historical product data may refer to past data, information, or statistics associated with one or more products. For example, historical product data may refer to product data, as described herein, corresponding to sales which have already occurred, or refer to product data which has already been stored in memory, such as memory 532 as referenced in FIG. 5. In some examples, historical product data may include data beginning from the time a product was first listed on a website. In an example, historical product data may refer to product data from a specific time period in the past, such as during a specific season of a year, or a specific month across different years. In some embodiments, obtaining product history may refer to receiving, retrieving, or creating product history. For example, system 100 may query memory 532 to retrieve historical product data. Historical product data may correspond to product data from one product or a set of products. A product set may include any set, group, or collection of products, as described herein. A product set may include one or more products which may be displayed on a system, such as system 100.

It will be recognized that comparison shopping websites may include limitations on the products displayed on the website. For example, comparison shopping websites may be influenced by factors such as speed, memory usage, efficiency, storage, user demand, or network traffic, which may present limits the comparison shopping websites must manage. In an example, websites including advertisements may have limitations on the products displayed in the advertisement, as the advertisement may have limited display space. In some embodiments, comparison shopping websites may include capacity constraints. Capacity constraints may refer to limitations on products displayed on a system. In some embodiments, capacity constraints may refer to constraints placed on products from different retailers which display products on the comparison shopping website. In some embodiments, a capacity constraint may be an allocation of memory to different retailers presented on the comparison shopping website. For example, the comparison shopping website may have 1000 gb of data storage available, and the comparison shopping website may allocate portions of the 100 gb data storage to different retailers. In some embodiments, a capacity constraint may include a numerical number of products. For example, the comparison shopping website may allocate a maximum of 1000 products to each retailer to display on the website. Such capacity constraints may be in place to allow compliance with desired efficiency, speed, or memory requirements, as described herein. It will be recognized that retailers may have a constrained amount of products they can present to the comparison shopping website. As such, retailers may choose desired products to present to the comparison shopping website such that they are in compliance with the capacity constraint. For example, a retailer may choose to display on the comparison shopping website products which the retailer would like to drive customer attention to, such as products which are in current demand or products which they would like to increase sales of. In some embodiments, capacity constraints may be dynamic. Dynamic capacity constraints may refer to capacity constraints capable of varying or changing. A dynamic capacity constraint may include a capacity constraint which changes over time, such as a capacity constraint which may increase during a specific timeframe. In an example, a capacity constraint may be dynamic such that the constraint increases for a predetermined duration, such as during a predicted timeframe of high consumer shopping. In another example, a capacity constraint may increase or decrease automatically due to feedback from the website, such as observed changes in user demand on the comparison shopping website. In an example, the capacity constraint may correspond to a data size, display size, or character limit for an advertisement. In some embodiments, capacity constraints may include constraints on an amount of new products which can be accommodated every day. For example, new products may refer to products or product data which may be transmitted for the first time to a comparison shopping website, such as in the example where the new product data is unknown to the comparison shopping website. In some examples, the capacity constraint may be a limit on the number of new products in addition to previously-presented products, or the capacity constraint may include a specific allocation or allotment for new products that may be different or the same as the allotment for previously presented products. In an example, the capacity constraint may include a separate capacity constraint specifically for new products.

It will be recognized that user interaction with the comparison shopping website may be an indication of user attention or user interest in products displayed. In some embodiments, user interaction with a comparison shopping website may be a click on a specific product. In some embodiments, user interaction may refer to a tracked interaction between the user and the website or display interface. For example, tracked interactions may include scrolls, mouse hovering, long presses, or product search popularity. Tracked interactions may also include shopping cart interactions, such as number of adds to shopping carts or number of times a product has been abandoned in shopping carts, searches for products or model numbers, or the like. It will be appreciated that interactions with the products displayed on the comparison shopping website may indicate user interest in purchasing the product from the comparison shopping website or from the listing retailer. For example, the user may click on a product and be redirected to the website of the retailer. Thus, it will be appreciated that a retailer may desire to present products to the comparison shopping website based on which products may correspond to a certain amount of interactions, such as choosing products which are interacted with more than other products.

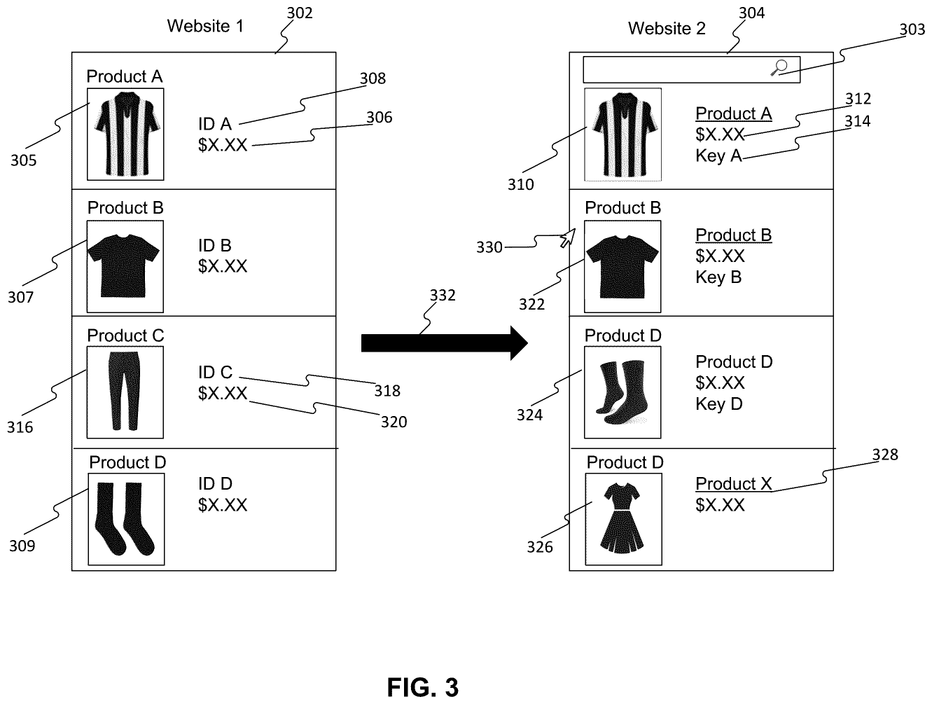

FIG. 3 illustrates an exemplary retail website and comparison shopping website, consistent with embodiments of the present disclosure. A first system as described herein may include retail website 302, and a second system may include comparison shopping website 304. Retail website 302 may display a number of products, such as first product 305, second product 307, third product 316, and fourth product 309, which may comprise a product set. Retail website 302 may include various features such as prices, pictures, product identifiers, reviews, and product data, as described herein. In some examples, product data may be displayed on retail website 302. For example, retail website 302 may display a product identifier 308 and price 306 corresponding to first product 304, as well as product identifier 318 and price 320 corresponding to price 316. In some examples, product data may not be displayed on retail website 302. comparison shopping website 304 may also display one or more products. A user may use search bar 303 to search for products or categories of products in comparison shopping website 304. For example, comparison shopping website 304 may display products corresponding to clothes if a user searched for clothes with search bar 303. Comparison shopping website 304 may display one or more products from various retailers or suppliers. In some embodiments, comparison shopping website 304 may display products from retail website 302 as well as other products not from retail website 302. For example, first product 310 displayed on comparison shopping website 304 may refer to first product 305 displayed on retail website 302. Similarly, second product 322 and third product 324 displayed on comparison shopping website 304 may correspond to second product 307 and fourth product 309 displayed on retail website 302. In some examples, not all products displayed on retail website 302 may have to be displayed on comparison shopping website 304, and vice versa. For example, comparison shopping website 304 may display fourth product 326, which may correspond to a second retail website other than retail website 302.

Some embodiments may involve transferring or transmitting information from a first system to a second system, such as transmitting data from retail website 302 to comparison shopping website 304. Transmitting data may involve mapping data from one system to another. For example, product data and product information may be sent from the retail website 302 to the comparison shopping website 304. As described herein, retailers may select products to display on the comparison shopping website based on factors such as business needs or predicted sales demand. For example, fourth product 309 displayed on retail website 302 may not be displayed on comparison shopping website 304.

In some embodiments, transmitting information between systems may include the use of product keys. A product feed key may refer to any piece of information used to retrieve data. For example, a product feed key may associate product data with a product name, display name, or display identifier. As such, a product feed key may comprise a product identifier and a price, such as first product identifier 308 and first product price 306 corresponding to first product 305. The product feed key may associate a product with information stored in memory or a database, and the product feed key may be used to retrieve or query the database or transmit or store information on the database. For example, a product feed key corresponding to first product 305 may be used to query a database to retrieve product information, including historical product information, from database.

Disclosed embodiments may involve mapping the product feed key from a product in a first set of products to a product in a second set of products. For example, a product feed key including product identifier 308 and price 306 corresponding to first product 305 may be mapped to comparison shopping website 304, which may display the first product 310 and corresponding product feed key including product identifier 312 and price 314. In some embodiments, transmission 332 between retail website 302 and comparison shopping website 304 may involve using documents or tools which can store and present data. A system may generate a file such as spreadsheet which includes product data and transmit the file to other systems. For example, retail website 302 may generate a spreadsheet and send the spreadsheet to comparison shopping website 304. The spreadsheet may include product data and product feed keys, such as product identifier 308 and price 306. Product feed keys may be used to query the spreadsheet and retrieve information, including product data, corresponding to products. For example, comparison shopping website 304 may receive the spreadsheet and use product feed keys to extract product information from the spreadsheet and display products on comparison shopping website 304.

Some disclosed embodiments may involve a capacity constraint associated with a second system configured to display information associated with one or more products. As described herein, products may be selected for display to enable compliance with the capacity constraint. For example, the number of products displayed on comparison shopping website 304, as referenced in FIG. 3, may be determined by a capacity constraint. The capacity constraint may limit how many products from a retail website, such as retail website 302, may be displayed on the comparison shopping website 304. It will be recognized that a machine learning model may be used to optimize the products transmitted form retail website 302 and displayed on comparison shopping website 304.

As discussed herein, disclosed embodiments may involve optimizing a product feed based on a machine learning model trained on product data. It will be recognized that providing data to a machine learning model may involve data aggregation. For example, historical product data in different locations, formats, scales, or file extensions may not be able to be used as an input to machine learning models in their existing form, such as product data stored in different tables in a database. Data processing, including data aggregation and/or standardization, may refer to combining data from various sources into a consistent, unified format. Data aggregation may involve applying various calculations to data to be able to combine data in a useful format. It will be recognized that some machine learning models may not be capable of receiving product data inputs without data standardization, as unnormalized features may not be compatible with one another.

Some disclosed embodiments involve applying one or more calculations to historical product data. For example, calculations may involve matrix operations, linear combinations, and scaling by various factors, such as taking a logarithm of data. The logarithm may be taken at various levels of historical product data, including on an individual data classification level, such as brand scores or category name. Some disclosed embodiments involve combining the historical product data into a unified record. A unified record may refer to any information storage system. The unified record may be a storage and retrieval system implemented on system 100. Some disclosed embodiments include storing the unified record in a database. For example, the unified record of the aggregated product data may be stored in database. It will be recognized that product data may include a large number of features, such as millions of features. Features may include various attributes of the product data, such as different attributes stored in memory 532. It will also be recognized that systems as described herein may involve many users, such as millions of users and billions of products in some examples, thereby creating large numbers of data for optimizing a product feed. Thus, it will be appreciated that conventional systems, including the human mind, are not capable of optimizing systems based on product data nor aggregating data for such purposes.

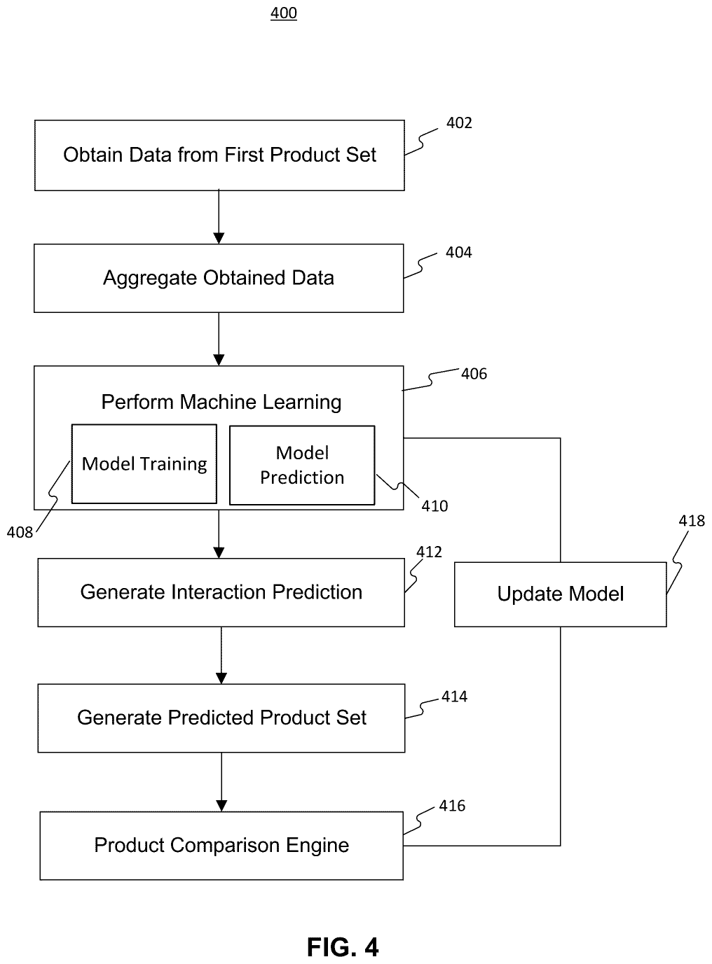

FIG. 4 illustrates an exemplary diagram for training and using a machine learning model, consistent with embodiments of the present disclosure. For convenience of description, method 400 may be described herein as being performed by a computer, such as computer 102B. However, the disclosed embodiments are not so limited. In some embodiments, method 400 may be performed by one or more processors, microprocessors, or computing systems. For example, method 400 may be performed by processor 530. Furthermore, the computer(s) used to train the machine learning model may differ or be separate from the computer(s) used to obtain the training data, the computer(s) used to generate the training dataset, or the computer(s) which may use the machine learning model for inference.

Method 400 may involve a step 402 of obtaining data from a first product set, such as obtaining historical product data from the products displayed on retail website 302, as described herein. For example, step 402 may involve obtaining the number of sales or searches for a given item in a collection of items displayed on retail website 302. The obtained data may be aggregated in step 404. Step 404 may involve aggregating the obtained data by combining the data into a consistent format, including applying various calculations to the data. Aggregating data may involve applying scaling functions, such as logarithms, to different data, as described herein. For example, sales data, review data, or delivery data may exist in different formats, and aggregating data may involve combining the data such that their formats become compatible with one another,

In some embodiments, data aggregation may be performed prior to performing machine learning in step 406. Performing machine learning may involve generating predictions based on inputs to a machine learning model. As described herein, the machine learning model may be trained on past data, such as historical product data. The aggregated data, as represented in step 404, may be an input to the machine learning model in step 406.

Some disclosed embodiments may involve a machine learning model trained on historical product data. Performing machine learning may involve model training 408, as referenced in FIG. 4. In some embodiments, training of the machine learning model comprises generating aggregated product data based on historical product data. Generating aggregated data, as described herein, may be performed at various time intervals. For example, historical product data may be gathered and aggregated on a daily basis, weekly basis, or monthly basis. By generating aggregated basis daily, the machine learning model may capture day-to-day changes in trends, such as customer purchase trends. In some embodiments, the historical product data corresponds to a historical time duration. A historical time duration may refer to a timeframe or period of time in the past. For example, a historical time frame may refer to a day, week, month, season, or year, or any combination thereof. The historical product data may include data which occurred during the time duration, such as data occurring in the most recent month. Some disclosed embodiments may involve inputting aggregated product data into the machine learning model daily. It will be recognized that the machine learning model may be trained at various intervals of time. For example, the system 100 may retrain the model by providing new or updated inputs on an hourly, weekly, or monthly basis. Based on daily updates to the aggregated product data, the model may perform training again. It will be appreciated that different intervals of time between model training can have various advantages. For example, aggregated inputs to the model can be refreshed daily, which may account for new patterns in product popularity, as well as new products available in the product feed, thereby enabling a better model and more accurate prediction.

In some embodiments, the machine learning model can be configured to generate a prediction which may be used to optimize a product feed. Optimizing a product feed may refer to choosing which products to include on a product feed, such as a comparison shopping website. Products may be chosen to be displayed on the product feed of a comparison shopping website to enable higher sales and customer traffic while complying with requirements of the comparison shopping website, such as capacity constraints. Thus, machine learning models may be configured to generate various predictions which may determine the selection of products to display on the comparison shopping website. Some disclosed embodiments may involve generating, with a machine learning model trained on historical product data, a predicted amount of interactions corresponding to at least one product in the first product set. Model prediction 410, as referenced in FIG. 4, may include generating a predicted amount of interactions with the trained machine learning model. The predicted amount of interactions may refer to a prediction of how much interaction a user will have with a specific product. In some embodiments, the predicted number of interactions may be the number of interactions in a future time period. For example, the predicted number of interactions may refer to the number of clicks, hovers, or long-presses a user would have with a specific product displayed on a product feed such as a comparison shopping website. The predicted number of interactions may be the total number of interactions in a given time period in the future, such as a specific day, week, month, season, or year. Thus, the generated interaction prediction, as represented in step 412, may provide insight into how popular one or more products may be to consumers in the future. As such, the comparison shopping website may be customized to display products which were predicted to be in demand during the future time period, as indicated by the interactions prediction.

FIG. 5 is an illustration of a user interacting with a system for optimizing a product feed, consistent with embodiments of the present disclosure. A user 502 may interact with a retail website 502 and/or a comparison shopping website 504 via mouse 510. In an example, user 506 establishes an interaction with product 508 by clicking on product 508 with mouse 510. As discussed herein, machine learning model 528 may generate a prediction for the amount of interactions between users and comparison shopping website 504. In some embodiments, machine learning model 528 may comprise any model configured to generate predictions of values, classify data, categorize data, rank data, or optimize outcomes. Machine learning model 528 may be any model configured to generate a prediction of a value, such as a capacity constraint. In some examples, machine learning model 528 may comprise a classifier, such as a logistic regression, random forest, nearest neighbor model, decision tree, or a clustering model, such as k-means model. In some examples, machine learning model 528 may comprise a data generation or optimization model, such as a hidden Markov model, generative adversarial network, or linear programming model. In some examples, machine learning model 528 may comprise a regression model, such as a linear regression model, neural network, or gradient boosting machine.

Some disclosed embodiments involve optimizing the machine learning model. Performing machine learning, as represented by step 406 in method 400, may involve optimizing the model during model training 408 and/or model prediction 410. Model optimization may refer to iterative adjustments or improvements to the machine learning model. Optimization may include optimizing inputs, weights, parameters, nodes, and outputs of the machine learning model. Parameters may include hyperparameters, which may be parameters external to the machine learning process. Hyperparameters may include values which can be adjusted to obtain a desired model performance. Hyperparameters may be set before training of the model, or adjusted between trainings. For example, an operator may select the values of hyperparameters before training begins and tune the hyperparameters as the model learns. As a non-limiting example, hyperparameters may include factors such as learning rate, iterations, random seeds, train-test split, dataset sizes, neural network nodes or layers, kernels, regularization, type of optimization, activation, cost, loss, or objective function, drop-out rate, batch size, pooling size, number of clusters. It will be recognized that by adjusting hyperparameters, the model may have improved predictive accuracy and speed. Adjusting hyperparameters may involve optimization of the hyperparameters, such as tuning one or more hyperparameters at a time. Hyperparameter optimization may involve any method of adjusting hyperparameters to achieve a desired goal. For example, hyperparameter optimization may be done by manual tuning, such as changing hyperparameter values through trial-and-error methods. Hyperparameter optimization may also involve grid search or random search methods. Some disclosed embodiments involve tuning one or more hyperparameters associated with the machine learning model by applying Bayesian optimization to the one or more hyperparameters. Bayesian optimization may involve finding desired hyperparameter values by building a probability model of the objective function. Bayesian optimization may learn from evaluations of previous pairs of combinations of hyperparameters to optimize the next pair. It will be appreciated that Bayesian optimization may reduce the number of iterations for tuning hyperparameters, thereby minimizing optimization time. For example, Bayesian optimization can be used to tune hyperparameters such as bagging fractions, bagging frequencies, feature fractions, learning rates, maximum depth, minimum data in a decision tree leaf, and number of decision tree leaves. It will be recognized that for large amounts of data, Bayesian optimization may reduce the optimization time. For example, using grid search for hyperparameter tuning may take a day, while Bayesian optimization may take 30 minutes. Further, it will be appreciated that hyperparameter optimization may assist in reducing model overfitting and/or underfitting.

As discussed herein, method 400 may include a step 412 of generating an interaction prediction. Generating an interaction prediction may refer to an interaction prediction for one or more products listed on a retail website, such as retail website 502, as referenced in FIG. 5. In some embodiments, machine learning model 528 may generate a predicted amount of interactions for each product displayed on retail website 502. For example, a billion products may be displayed on retail website 502, and one iteration of machine learning model 528 may generate a predicted interaction count for each product. In some embodiments, machine learning model 528 may generate a predicted amount of interactions for one product displayed on retail website 502. For example, machine learning model 528 may run one or more times and generate an interaction prediction each time. In some embodiments, method 400 may include a step 414 of selecting a predicted product set. Some disclosed embodiments involve selecting, based on the predicted amount of interactions, a second product set. The second product set may be selected based on the output of the machine learning model. For example, the second product set may be chosen such that the selected products correspond to products with the predicted highest amount of interactions. In some embodiments, the second product set includes a subset of the products from the first product set based on the capacity constraint. The second product set may include one or more products from the first product set, such as products displayed on retail website 302. Depending on the capacity constraint, various amounts of products can be selected from the first product set to form the second product set, such as in the example of a numerical capacity constraint, where the number of selected products in the second product set may be less than or equal to the value of the capacity constraint. For example, if the capacity constraint is a number such as 100, products from the first product set which have the 100 highest predicted interactions may be selected to form the second product set. In some embodiments, the model output may be a label, such as a classification label. For example, the model may be configured to generate an output of a label such as “no interaction”, “low interaction”, or “high interaction” for the predicted interactions.

Some disclosed embodiments involve presenting the second product set to the second system. Referring to FIG. 4, method 400 may involve a step 416 of presenting the predicted product set to the comparison shopping website. As discussed herein, communication between a first system and a second system, such as transmission of data between retail website 302 and comparison shopping website 304, may involve using documents or tools which can store and present data, including spreadsheets. Machine learning model 528 may generate a predicted amount of interactions for products in retail website 502, as referenced in FIG. 5. For example, machine learning model 528 may generate predictions of the number of clicks for each of first product 505, second product 507, third product 516, and fourth product 509. Processor 530 may store data corresponding to the machine learning model, including the generated predictions, product data, and product feed keys, in memory 532. Processor 530 may select products from retail website 502 to be presented on comparison shopping website 504. For example, the capacity constraint for comparison shopping website 504 may establish a limit of three products from each system displaying products on the comparison shopping website 504. In an example where the three products listed on retail website 302 with the highest interaction predictions are first product 505, second product 507, and fourth product 509, these products may be stored in memory 532 and/or presented to comparison shopping website 504. For example, first product 505, second product 507, and fourth product 509 may be stored in a spreadsheet including the corresponding product data and product identifiers, and the spreadsheet may be presented to comparison shopping website 504. Comparison shopping website 504 may represent a second system configured to receive the spreadsheet with the product information, and then comparison shopping website 504 may display the selected products. For example, comparison shopping website 504 may display first product 511, second product 522, and fourth product 526. It will be appreciated that as the aforementioned products correspond to products with the top interaction predictions, these products may be more likely to be selected by a consumer, such as user 506, thereby increasing efficiency in web page delivery by directing consumer attention to a most-likely desired product set. As an additional example, the aforementioned products may be presented on a shopping advertisement, such displaying the products with the predicted top interactions on the advertisement, thereby increasing efficiency of the displayed advertisement by directed consumer attention to a limited number of products in the advertisement.

In some embodiments, method 400 may include a step 418 of updating the machine learning model. It will be recognized that the machine learning model may be trained and updated to account for new data and to increase accuracy of the model output. In some embodiments, the machine learning model may be updated and retrained based on the first system, including training the machine learning model on historical product data corresponding to a first set of products, as well as training the machine learning model based on a second system. In some embodiments, the machine learning model is updated by obtaining a product feed and a product feed interaction count from the second system. Obtaining the product feed may refer to receiving data from one or more products displayed on the product feed, including receiving product data and product feed keys. Obtaining product feed interaction counts may refer to receiving data corresponding to the amount of interactions a product has, including the number of times a product has been clicked. For example, a product feed interaction count may include the number of clicks a consumer such as user 506 has with products on comparison shopping website 504. Some embodiments involve providing at least one of the product feed or the product feed interaction count to the machine learning model. For example, data corresponding to products such as first product 511, second product 522, or fourth product 508 may be new or updated product data which can be transmitted to machine learning model 508. Machine learning model 508 may receive new product data, such as data corresponding to products which have not previously been trained on, products which do not yet have historical product data. New product data may refer to data from products which have been added to a product feed between model refreshes or prediction generations. For example, new product data may include products added to comparison shopping website 504 which have not been included in first product set corresponding to products on retail website 502. In some embodiments, updating or training the model includes updating one or more weights in the machine learning model by training the machine learning model based on the product feed and/or the product feed interaction count. It will be recognized that machine learning models as described herein may include weights which assign a relative importance to a parameter or variable. By updating one or more weights in the machine learning model, the machine learning model may be retrained based on different datasets or updated datasets. For example, machine learning model 528 may consider inputs and determine which variables, such as different product data, may be more important by determining which features contribute to the least errors in a loss function minimization, such as least errors, least squared errors, absolute loss, root mean squared error, or the like. It will be appreciated that step 418 of updating the model may be performed at various intervals, such as every week, to ensure the model is updated and retrained to capture new trends and new products.

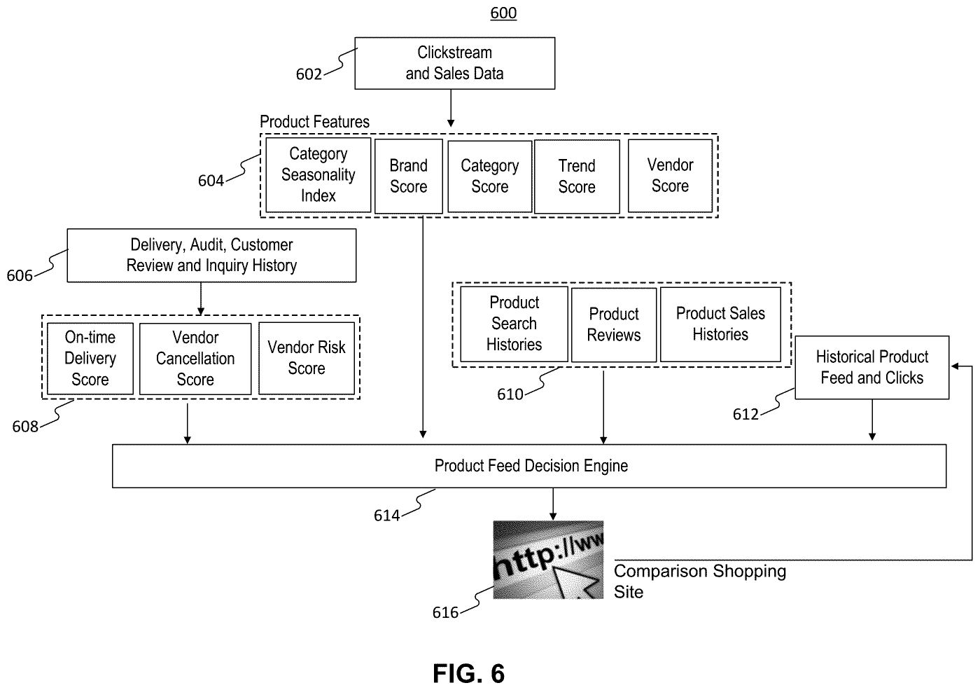

FIG. 6 illustrates a block diagram of inputs to a machine learning model, consistent with embodiments of the present disclosure. Diagram 600 may include clickstream and sales data 602. Derived feature products 604 may include features derived from clickstream and sales data 602, such as a category seasonality index, brand score, category score, trend score, and vendor score. Clickstream data 602 may include analytics and data corresponding to user behavior for a webpage, including records of user clicks and user visits on the webpage, or the like. Sales data 602 may include analytics and data corresponding to sales information for products—profits, gross, number of units per month, or the like. Vendor scores 608 may include features derived inquiry history 606, such as delivery scores, vendor cancellation scores, and risk scores, or the like. Product scores 610 may include any product data such as product search history, product reviews, and product sales data, or the like. Derived feature products 604, vendor scores 608, product scores 610, and historical product data 612 may each be inputs to decision engine 614, which may comprise a machine learning model such as machine learning model 528. Decision engine 614 may output a predicted selection of products to comparison shopping website 616. Data from comparison shopping website 616 may include historical product data 612, new product data, and product feed interactions, which may be inputs to the decision engine to update and refresh the model.

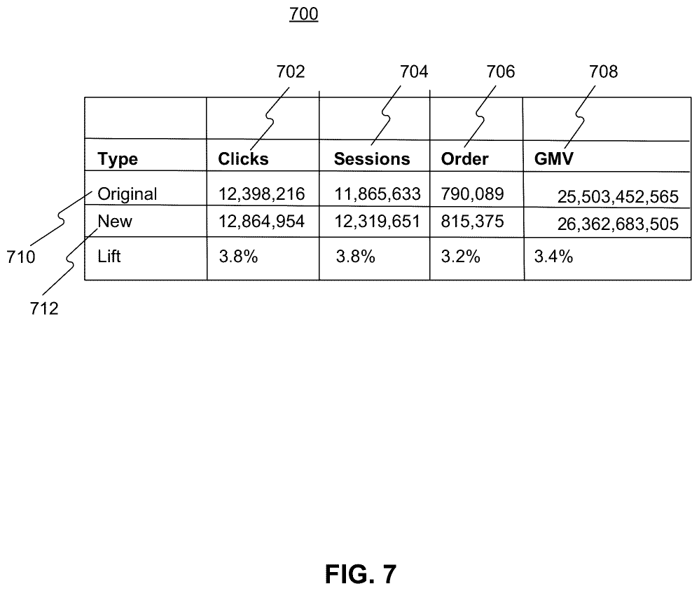

FIG. 7 illustrates a table displaying test results for a machine learning model, consistent with embodiments of the present disclosure. Embodiments of the present disclosure were implemented using an A/B testing scheme, to determine the efficiencies and advantages of the disclosed embodiments. Table 700 displays A/B testing results for product demand data on a product feed system displaying a second product set. For example, table 700 may display data for a comparison shopping website over a two-week period. Product demand data may include indicators of how much consumer attention products receive, such as user interactions represented by clicks in column 702, user sessions in row 704, total orders in row 706, and gross merchandise value in row 708. Data in row 710 displays data corresponding to conventional methods of selecting products for a product feed, including manual methods as described herein, while data in row 712 displays data corresponding to methods for optimizing a product feed based on a machine learning model trained on product data. Data in row 714 represents the percent change in product demand data. As displayed in table 700, machine-learning based optimization of the product feed results in a 3.8% increase in user clicks, a 3.8% increase in user sessions, a 3.2% increase in orders, and a 3.4% increase in gross merchandise value (in Korean won). Thus, it will be appreciated that embodiments of the disclosed machine-learning based optimization methods provide improvements over manual methods as well as conventional methods such as random selection, of selecting products to display on a comparison shopping website.

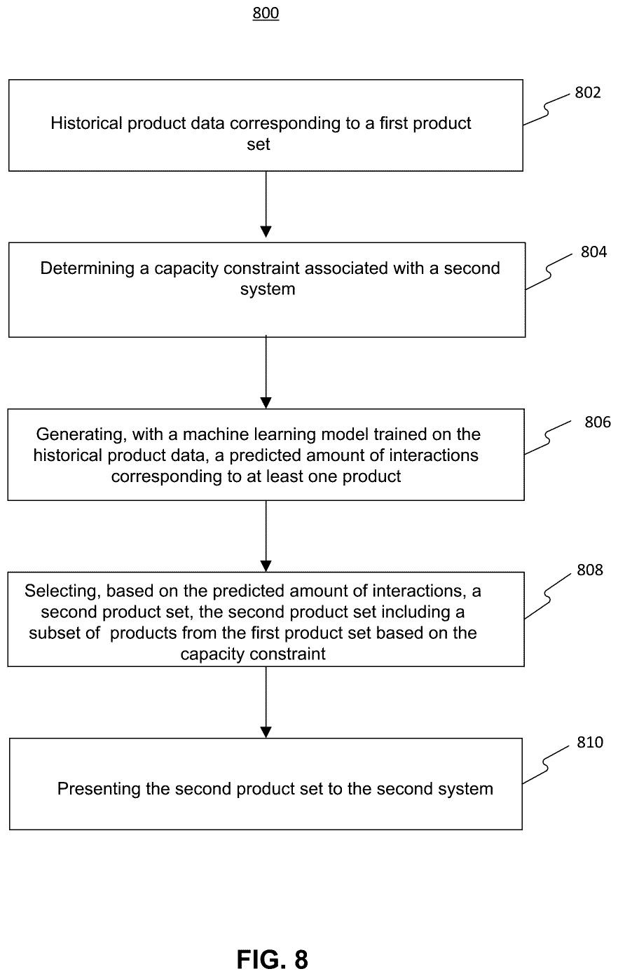

FIG. 8 is an illustration of a flow diagram of a method for optimizing a product feed based on a machine learning model, consistent with disclosed embodiments. In some examples, method 800 may be executed by computer 102B. In some embodiments, method 800 may include a step 802 of obtaining historical product data corresponding to a first product set, the first product set comprising one or more products for display on a webpage associated with the system.

Method 800 may include a step 804 of determining a capacity constraint associated with a second system configured to display information associated with the one or more products. In some examples, the capacity constraint may be a numerical limit on the number of items that can be displayed on the second system, such as a limit on the number of products that can be displayed on a comparison shopping website. In some examples, the capacity constraint may include a limit on the size of the data, such as a limit for a maximum amount of storage or memory which can be occupied by data corresponding to the set of products.

Method 800 may include a step 806 of generating, with a machine learning model trained on the historical product data, a predicted amount of interactions corresponding to at least one product in the first product set. As discussed herein, generating with the machine learning model may involve outputting a prediction from the machine learning model. In some examples, inputs to the machine learning model may include aggregated product data corresponding to one or more products in a set of products. By training on the historical product data, the machine learning model may generate a predicted amount of interactions, for a future time period, for a product in the set of products. In one example, the machine learning model may generate a predicted amount of interactions for multiple products in the set of products.

Method 800 may include a step 808 of selecting, based on the predicted amount of interactions, a second product set, wherein the second product set includes a subset of the products from the first product set based on the capacity constraint. It will be recognized that, in some examples, not all products in the first product set may be able to be displayed on the second system. For example, it may be desired to select only products that satisfy an interaction prediction threshold, such as a determined minimum number of interactions, and selecting as many of those satisfactory products to be part of a second product set, while also ensuring that the total number of those satisfactory products are at or below a given capacity constraint.

Method 800 may include a step 810 of presenting the second product set to the second system. By presenting the second product set to the second system, the second product set may become available for display on the second system. Thus, the displayed products may correspond to products which have a certain interaction prediction, as predicted by the machine learning model, and thereby may be more likely to be interacted with and drive user traffic to retail websites. In some examples, presenting the second product set to the second system may allow for further refinement of the machine learning model, as product data corresponding to the second system may be used to train and update the machine learning model, thereby increasing the prediction accuracy of the model.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system comprising:
at least one memory storing instructions;
at least one processor configured to execute the instructions to perform operations for optimizing a product feed based on a machine learning model trained on product data, the operations comprising:
obtaining historical product data corresponding to a first product set, the first product set comprising one or more products for display on a webpage associated with the system;
determining a capacity constraint associated with a second system configured to display information associated with the one or more products;
generating, with a machine learning model trained on the historical product data, a predicted amount of interactions corresponding to at least one product in the first product set;
selecting, based on the predicted amount of interactions, a second product set, wherein the second product set includes a subset of the products from the first product set based on the capacity constraint; and
presenting the second product set to the second system.

2. The system of claim 1, wherein training of the machine learning model comprises:
generating, on a daily basis, aggregated product data based on the historical product data, the historical product data corresponding to a historical time duration, by:
applying one or more calculations to the historical product data;
combining the historical product data into a unified record;
storing the unified record in a database; and
inputting the aggregated product data into the machine learning model daily.

3. The system of claim 2, further comprising optimizing the machine learning model;
wherein optimizing comprises tuning one or more hyperparameters associated with the machine learning model by applying Bayesian optimization to the one or more hyperparameters.

4. The system of claim 2, wherein the machine learning model is configured to generate the predicted amount of interactions based on at least one of historical product data or new product data.

5. The system of claim 2, further comprising updating the machine learning model by:
obtaining from the second system:
a product feed; and
a product feed click count;
providing at least one of the product feed or the product feed click count to the machine learning model; and
updating one or more weights in the machine learning model by training the machine learning model based on the at least one of the product feed or the product feed click count.

6. The system of claim 5, wherein the machine learning model is updated daily.

7. The system of claim 1, wherein the historical product data include at least one of vendor information, score information, product review information, customer information, sales information, or interactions corresponding to the retail website.

8. The system of claim 1, wherein a total amount of products in the second product set is no more than the capacity constraint.

9. The system of claim 1, further comprising associating each product in the first set of products with a product feed key, the product feed key comprising a product identifier and a price; and mapping the product feed key to a product in the second system.

10. The system of claim 1, wherein the generated predicted amount of interactions corresponds to a future time period.

11. A method for optimizing a product feed based on a machine learning model trained on product data, comprising:
obtaining historical product data corresponding to a first product set, the first product set comprising one or more products for display on a webpage associated with the system;
determining a capacity constraint associated with a second system configured to display information associated with the one or more products;
generating, with a machine learning model trained on the historical product data, a predicted amount of interactions corresponding to at least one product in the first product set;
selecting, based on the predicted amount of interactions, a second product set, wherein the second product set includes a subset of the products from the first product set based on the capacity constraint; and
presenting the second product set to the second system.

12. The system of claim 1, wherein training of the machine learning model comprises:
generating, on a daily basis, aggregated product data based on the historical product data, the historical product data corresponding to a historical time duration, by:
applying one or more calculations to the historical product data;
combining the historical product data into a unified record;
storing the unified record in a database; and
inputting the aggregated product data into the machine learning model daily.

13. The system of claim 2, further comprising optimizing the machine learning model;
wherein optimizing comprises tuning one or more hyperparameters associated with the machine learning model by applying Bayesian optimization to the one or more hyperparameters.

14. The system of claim 2, wherein the machine learning model is configured to generate the predicted amount of interactions based on at least one of historical product data or new product data.

15. The system of claim 2, further comprising updating the machine learning model by:
obtaining from the second system:
a product feed; and
a product feed click count;
providing at least one of the product feed or the product feed click count to the machine learning model; and
updating one or more weights in the machine learning model by training the machine learning model based on the at least one of the product feed or the product feed click count.

16. The system of claim 5, wherein the machine learning model is updated daily.

17. The system of claim 1, wherein the historical product data include at least one of vendor information, score information, product review information, customer information, sales information, or interactions corresponding to the retail website.

18. The system of claim 1, wherein a total amount of products in the second product set is no more than the capacity constraint.

19. The system of claim 1, further comprising associating each product in the first set of products with a product feed key, the product feed key comprising a product identifier and a price; and mapping the product feed key to a product in the second system.

20. A non-transitory computer readable medium including instructions that are executable by one or more processors to cause a system to perform a method for optimizing a product feed based on a machine learning model trained on product data, the method comprising:
obtaining historical product data corresponding to a first product set, wherein the first product set comprising one or more products for display on a webpage associated with the system;
determining a capacity constraint associated with a second system configured to display information associated with the one or more products; wherein the capacity constraint comprises a numerical limit;
generating a gradient boosting machine regression model configured to generate a predicted amount of interactions corresponding to at least one product in the first product set;
training, on a daily basis, the gradient boosting machine regression model by:
generating aggregated product data based on the historical product data;
inputting the aggregated product data into the gradient boosting machine;
obtaining from the second system:
a product feed; and
a product feed click count;
providing at least one of the product feed or the product feed click count to the machine learning model; and
updating one or more weights in the machine learning model based on the at least one of the product feed or the product feed click count;
optimizing the trained gradient boosting machine model by applying Bayesian optimization to one or more hyperparameters associated with the trained gradient boosting machine model;
generating, with the optimized gradient boosting machine model, the predicted amount of interactions; wherein the predicted amount of interactions corresponds to a future time interval;
selecting, based on the predicted amount of interactions, a second product set, wherein the second product set includes a subset of the one or more products from the first product set based on the capacity constraint; and
presenting the second product set to the second system for display during the future time interval.
